(19) United States
(12) Patent Application Publication
(10) Pub. No.: US 2013/0166969 A1
(43) Pub. Date: Jun. 27, 2013

(54) METHOD AND SYSTEM FOR ENHANCED HELP INSTRUCTIONS

(71) Applicants: Jun Zhang, Hamden, CT (US); Zhenan Hong, Shelton, CT (US); David L. Andrews, South Salem, NY (US); Yuling Wu, Scarsdale, NY (US); Robert A. Cordery, Monroe, CT (US)

(72) Inventors: Jun Zhang, Hamden, CT (US); Zhenan Hong, Shelton, CT (US); David L. Andrews, South Salem, NY (US); Yuling Wu, Scarsdale, NY (US); Robert A. Cordery, Monroe, CT (US)

(73) Assignee: Pitney Bowes Inc., Stamford, CT (US)

(21) Appl. No.: 13/337,858

(22) Filed: Dec. 27, 2011

(51) Int. Cl. G06F 11/07; G06K 19/06

(52) U.S. Cl. 714/57; 235/487; 714/E11.025

(57) ABSTRACT

A computerized method and system for providing enhanced help messages for equipment operation is described herein. A device having a processor automatically detects an error condition in the device, and determines that the error condition requires operator action. An appropriate message is selected that indicates a required operator action corresponding to the error condition. The message is configured to include a scannable barcode. The scannable barcode includes a website link to a website having more detailed information to assist an operator in performing the operator action. The message is displayed on a screen so that the operator can scan the barcode with his mobile device, and see the more detailed information on how to perform the required operator action. Alternatively, the message is configured as radio frequency data to be transmitted by the equipment using near field communication (NFC) technology to a mobile device having an NFC receiver.

### FIELD OF THE INVENTION

The present invention relates generally to using a mobile device to provide enhanced help instructions to the operator of a piece of equipment.

### BACKGROUND OF THE INVENTION

Machines such as postage meters, printers, copiers usually have small displays to show status or error information pertinent to the equipment. The information that can be displayed is very limited due to the small space. Accordingly, it can be difficult for a user to determine what corrective action needs to be taken in order to correct an error.

### SUMMARY OF THE INVENTION

A computerized method and system for providing enhanced help messages for equipment operation is described herein. A device having a processor automatically detects an error condition in the device, and determines that the error condition requires operator action. The device selects a message that indicates a required operator action corresponding to the error condition. The message is configured to include a scannable barcode. The scannable barcode includes a website link to a website having more detailed information to assist an operator in performing the needed operator action. The message is displayed on a screen so that the operator can scan the barcode with his mobile device, and see the more detailed information on how to perform the required operator action. In a preferred embodiment, the scannable barcode is in QR Code format. In an alternative embodiment, the message is configured as a radio frequency message to be transmitted by the equipment using near field communication (NFC) technology to a mobile device having an NFC receiver.

The detailed information on the website can include a set of written instructions, graphical diagrams, or a video including instruction pertinent to the operator action. Further, in preferred embodiments, the scannable barcode includes a product code or an error code so that the relevant information for the product or the error can be provided by website.

### BRIEF DESCRIPTION OF THE DRAWINGS

FIG. 1 depicts an exemplary postage meter device having small display screens.

FIG. 2 shows exemplary error messages that might be displayed on a small display screen of a device.

FIG. 3 depicts an exemplary error message with a corresponding 2D barcode.

FIG. 4 depicts components of a device utilizing the enhanced help instructions.

FIG. 5 shows steps for using a mobile device to get enhanced instructions.

FIG. 6 shows components of a system using the invention.

### DETAILED DESCRIPTION

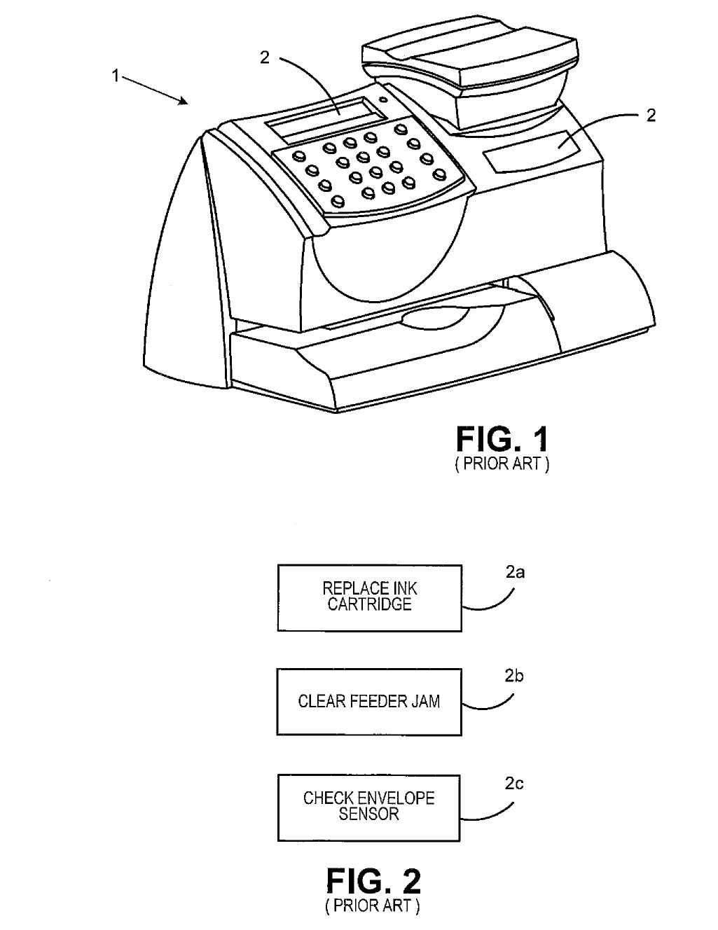

FIG. 1 shows a typical device 1 that has small display screens 2. This particular device 1 is a postage meter that feeds envelopes across a printing module for printing postage indicia. Exemplary error messages for a device 1 might include “REPLACE INK CARTRIDGE,” “CLEAR FEEDER JAM,” or “CHECK ENVELOPE SENSOR,” as shown in FIG. 2 (reference numbers 2a, 2b, and 2c). For an operator who is not familiar with how the machine works, the operator actions required to correct these errors may not be easy. An operator could consult a manual for the device, but manuals can be misplaced or lost. Also, some manuals are cumbersome to use and finding the relevant information can be difficult.

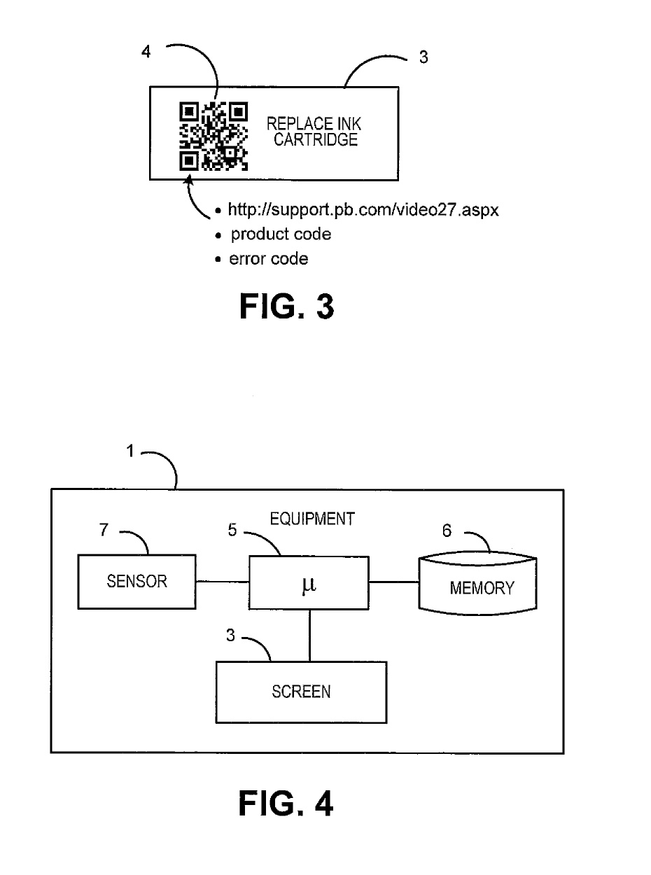

An improvement to the existing art is represented in FIG. 3. The improvement is the 2D barcode 4 that is displayed on the screen 3 alongside the error message. That 2D barcode 4 includes an encoded website address for a website that includes more detailed instruction on how to carry out the required operator action. Using known software on a smart phone, the operator can scan the barcode 4 to automatically access the website for enhanced instructions. The barcode 4 may also include a product code and/or an error code so that information provided on the website may be further refined to address the particular needs in connection with the error message.

For purposes of this invention, an “error message” and the corresponding remedial actions should be understood to cover a wide range of activities. For example, the error message could be a low level of consumable supplies, such as paper or ink, and the corresponding operator action could be ordering supplies through a link supplied in the barcode. In another example, scanning the barcode could give the operator access to a complete on-line version of a manual for the equipment. In the instance of a postage meter, the barcode could include a link to account information relating to postal funds and meter usage, and possibly include an interface to request replenishment of postal funds on the equipment.

Exemplary components for the device 1 are shown in FIG. 4. A microprocessor 5 is in operative connection to a screen 3, a memory 6, and a sensor 7. In this embodiment, sensor 7 detects when an error has occurred in the device and communicates with processor 5. The processor 5 accesses memory 6 and determines the nature of the error, and an appropriate error message to display on screen 3. For purposes of this invention, an error should not be limited to a failure of the device, and may also include required maintenance actions. Error messages can be generated without the use of a sensor 7, for example when a maintenance action is triggered based on a certain amount of time passing, or by a certain number of operations being performed by the device.

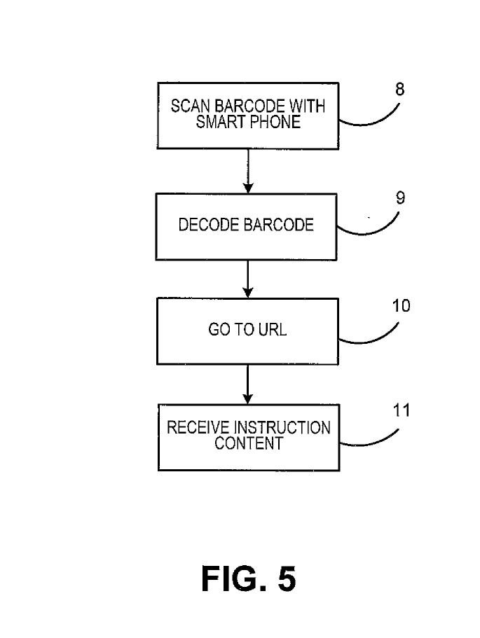

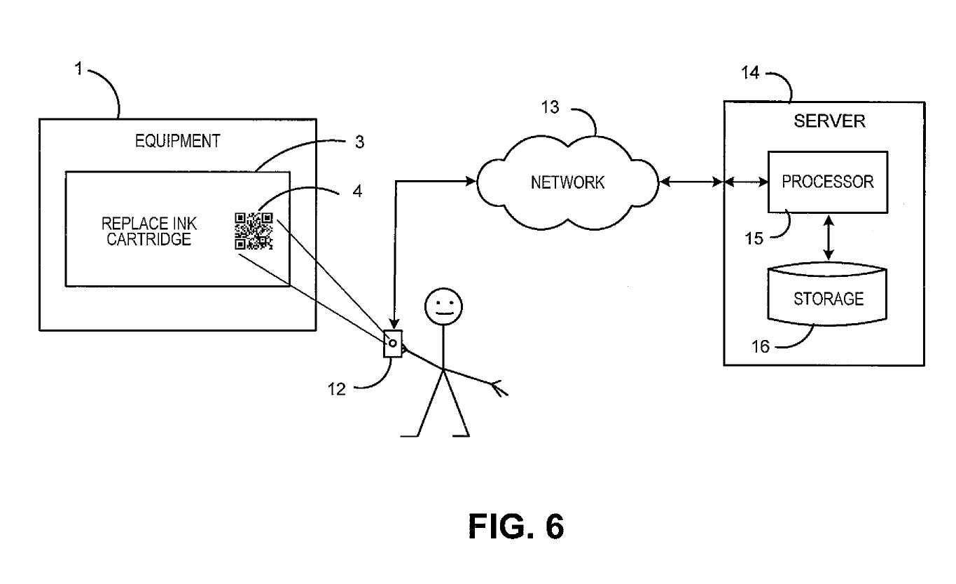

FIGS. 5 and 6 shows the flow of steps for using a smart phone in connection with the enhanced instruction system. As shown in step 8, a user with a mobile device 12 scans the barcode 4 from screen 3 of equipment 1. The smart phone 12 decodes the barcode 4 to derive the website address URL (step 9). The smart phone 12 goes to the URL (step 10) by accessing the website server 14 via the network 13. Preferably the network is the Internet which is accessed through the smart phone's service provider. A processor 15 at the server 14 receives the URL access request from the smart phone 12 and accesses storage 16 to provide the appropriate website information. If barcode includes further information from the barcode, including a product code, or an error code, the server processor 15 can determine further detailed information and instructions from storage 16 to provide in response to the information request.

In an alternative embodiment, instead of encoding the relevant data in a barcode, the relevant data can be transmitted via a radio frequency (RF) transmitter in conjunction with, or in lieu of, the barcode 4 on screen 3. An exemplary RF transmitter would use known near field communication (NFC) format, compatible with NFC RF receivers included in existing smart phones. Thus, a mobile device 12 can scan the equipment 1 screen 2, and/or corresponding RF transmitter, and the same process is followed as described above in connection with FIGS. 5 and 6.

Although the invention has been described with respect to preferred embodiments thereof, it will be understood by those skilled in the art that the foregoing and various other changes, omissions and deviations in the form and detail thereof may be made without departing from the scope of this invention.

1. A computerized method for providing enhanced help messages for equipment operation, the method comprising:
automatically detecting an error condition in a device having a processor;
determining, with the processor, that the error condition requires operator action;
selecting, with the processor, a message indicating operator action corresponding to the error condition;
configuring the message to include a scannable barcode, the scannable barcode being generated to include a website link to a website having more detailed information to assist an operator in performing the operator action; and
displaying the message on a screen.

2. The method of claim 1 further including the step of maintaining a website corresponding to the website link in the scannable barcode, the website having more detailed information relating to the operator action.

3. The method of claim 2 wherein the more detailed information includes a set of written instructions relating to the operator action.

4. The method of claim 2 wherein the more detailed information includes graphical diagrams pertinent to the operator action.

5. The method of claim 2 wherein the more detailed information includes a video including instruction pertinent to the operator action.

6. The method of claim 2 wherein step of providing the scannable barcode further includes providing a product code in the barcode, the product code being utilized by the website to provide information relevant to the product.

7. The method of claim 2 wherein step of providing the scannable barcode further includes providing an error code in the barcode, the error code being utilized by the website to provide information relevant to the error condition.

8. The method of claim 1 wherein the scannable barcode is configured as a QR barcode.

9. The method of claim 1 further including a step of configuring the message to include an encoded RF message, the encoded RF message to include the website link to the website having more detailed information to assist the operator in performing the operator action; and
transmitting the message with an RF transmitter on the equipment.

10. A computerized system for providing enhanced help messages for equipment operation, the system comprising:
a device having a processor, the processor configured to operate to:
automatically detect an error condition in the device;
determine that the error condition requires operator action;
select an error message to provide to an operator;
configure the message to include a scannable barcode, the scannable barcode being generated to include a website link to a website having more detailed information to assist an operator in performing the operator action; and
a screen coupled to the processor and configured for displaying the message provided by the processor.

11. The system of claim 10 further including a website server including a website corresponding to the website link in the scannable barcode, the website having more detailed information relating to the operator action.

12. The system of claim 11 wherein the more detailed information includes a set of written instructions relating to the operator action.

13. The system of claim 11 wherein the more detailed information includes graphical diagrams pertinent to the operator action.

14. The system of claim 11 wherein the more detailed information includes a video including instruction pertinent to the operator action.

15. The system of claim 11 wherein the processor is further configured to include a product code in the barcode, the website server configured to utilize the product code to provide website information relevant to the product.

16. The system of claim 11 wherein the processor is further configured to include an error code in the barcode, the website server configured to utilize the error code to provide website information relevant to the error condition.

17. The system of claim 10 wherein the processor is further configured to configure the message to include an encoded RF message, the encoded RF message including the website link to the website having more detailed information to assist the operator in performing the operator action; and
a transmitter coupled to the processor and configured for transmitting the message.

18. A computerized method for providing enhanced help messages for equipment operation, the method comprising:
automatically detecting an error condition in a device having a processor;
determining, with the processor, that the error condition requires operator action;
selecting, with the processor, a message indicating operator action corresponding to the error condition;
configuring the message to include an encoded RF message, the encoded RF message being generated to include a website link to a website having more detailed information to assist an operator in performing the operator action; and
transmitting the message with an RF transmitter on the equipment.

19. A computerized system for providing enhanced help messages for equipment operation, the system comprising:
a device having a processor, the processor configured to operate to:
automatically detect an error condition in the device;
determine that the error condition requires operator action;
select an error message to provide to an operator;
configure the message to include an encoded RF message, the encoded RF message being generated to include a website link to a website having more detailed information to assist an operator in performing the operator action; and
a transmitter coupled to the processor and configured for transmitting the message.
